(19) United States
(12) Patent Application Publication
(10) Pub. No.: US 2016/0216866 A1
(43) Pub. Date: Jul. 28, 2016

(54) Method for Inputting Text to Handheld Computer by Using Personal Computer

(71) Applicants: Ping-Shun Zeung, Taipei City (TW); Hao-Hsun Hou, Taipei City (TW)

(72) Inventors: Ping-Shun Zeung, Taipei City (TW); Hao-Hsun Hou, Taipei City (TW)

(73) Assignee: I/O INTERCONNECT, LTD., Santa Ana, CA (US)

(21) Appl. No.: 14/881,135

(22) Filed: Oct. 12, 2015

Related U.S. Application Data
(63) Continuation-in-part of application No. 14/607,046, filed on Jan. 27, 2015.

(51) Int. Cl. G06F 3/0484; G06F 3/0488

(52) U.S. Cl. CPC G06F 3/04842; G06F 3/0488

(57) ABSTRACT

A method for inputting text to a handheld computer by way of using the keyboard on a personal computer connected thereto. The method includes the steps of: a) establishing an ADK connection between a handheld computer and a personal computer with a keyboard; b) opening a WINDOWS input mode under an editing mode in the personal computer; c) inputting text and/or symbols by using the keyboard and the WINDOWS input mode; d) converting the text and/or symbols into a format acceptable by the handheld computer; and e) transferring the converted text and/or symbols to the handheld computer.

### CROSS-REFERENCE TO RELATED APPLICATIONS

This application is a continuation-in-part of U.S. patent application Ser. No. 14/607,046, filed Jan. 27, 2015, now pending.

### BACKGROUND OF THE INVENTION

1. Technical Field

The invention relates to handheld computers such as smartphones or tablet computers, particularly to inputting text into a handheld touchscreen computer by way of using a personal computer with a text input device such as a keyboard.

2. Related Art

Handheld computers, such as smartphones and tablets, have become essential for most people. Some users of handheld touchscreen computers will connect their handheld computers to an external personal computer such as a desktop or a laptop computer to serve as a second computer. For such users, there may on occasions arise the need to input a large amount of text into their handheld computers. Although personal computers are almost always equipped with keyboards, normally a user cannot use the keyboard on the personal computer to input text into the handheld computer, even though that handheld computer is connected to the personal computer. As convenience goes, inputting text by a keyboard are still far easier and faster than inputting text on a touchscreen. However, there is no solution on the market that can facilitate this convenience yet.

### SUMMARY OF THE INVENTION

An object of the invention is to provide a method for inputting text to a handheld computer that is connected to a personal computer, by way of using the keyboard on the personal computer to type up the text and send it to the handheld computer.

To accomplish the above object, the method of the invention includes the steps of:
a) establishing an ADK connection between a handheld computer and a personal computer with a keyboard;
b) opening a WINDOWS input mode under an editing mode in the personal computer;
c) inputting text and/or symbols by using the keyboard and the WINDOWS input mode;
d) converting the text and/or symbols into a format acceptable by the handheld computer; and
e) transferring the converted text and/or symbols to the handheld computer.

### BRIEF DESCRIPTION OF THE DRAWINGS

FIG. 1 is a schematic view of hardware arrangement of the invention;

FIG. 2 is a flowchart of the method of the invention; and

FIG. 3 is a schematic view showing the text input from the personal computer to the handheld computer.

### DETAILED DESCRIPTION OF THE INVENTION

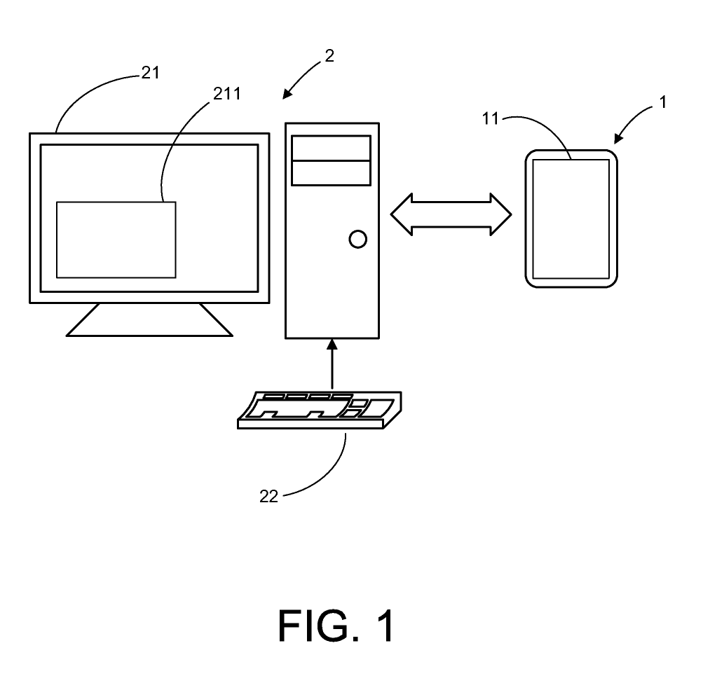

Please refer to FIG. 1. The invention provides a method for inputting text to a handheld computer 1 by using a keyboard 22 of a personal computer 2. The personal computer 2 may be a desktop or laptop computer. The handheld computer 1 may be a smartphone or tablet computer. Of course, the handheld computer 1 and the personal computer 2 must be provided with a first display 11 and a second display 21, respectively. Additionally, the personal computer 2 is provided with a keyboard 22. At the present time, the invention is designed for an ANDROID-based handheld computer 1 and a personal computer 2 with a WINDOWS operating system. However, it will be possible in the future that the invention can be applied in handheld computers and personal computers with other operating systems.

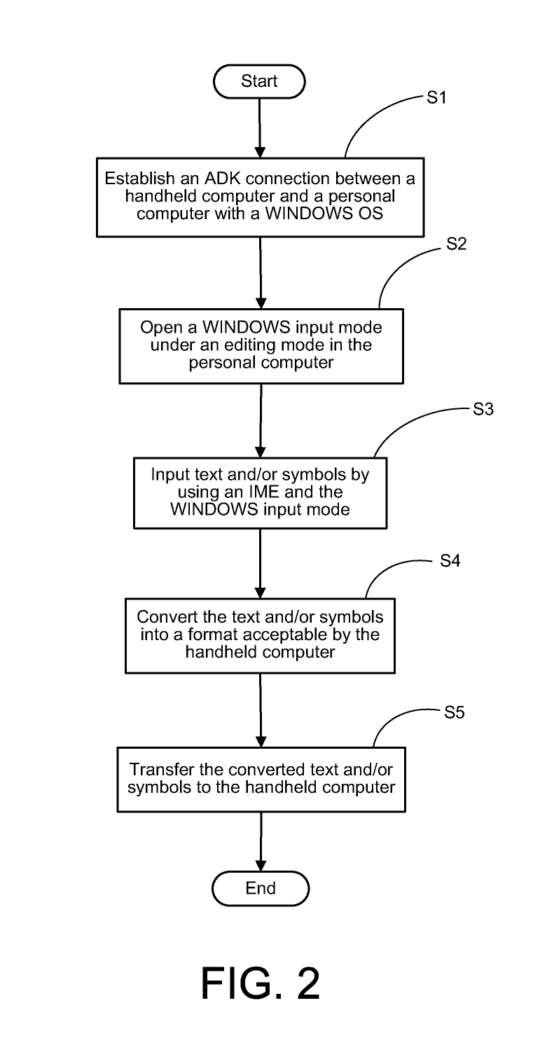

Please refer to FIG. 2, which shows a flowchart of the method of the invention. In step S1, an ADK (Accessory Development Kit) connection is established between the handheld computer 1 and the personal computer 2. The ADK is a reference implementation for hardware manufacturers and hobbyists to use as a starting point for building accessories for Android. The ADK connection can be implemented by a USB (universal serial bus) cable (not shown).

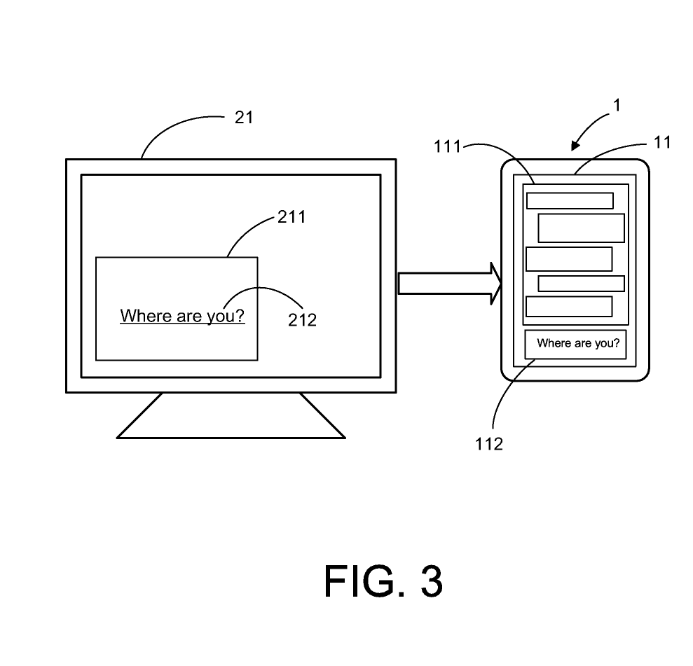

In step S2, a WINDOWS input mode under an editing mode is opened in the personal computer 2 when a software application, which needs to be inputted with text such as an instant messaging (IM) application, is shown on the second display 11 as shown in FIG. 3. And an input subwindow 211 for inputting text is shown on the second display 21 of the personal computer 2. Also, the input subwindow 211 could be a projected screen picture of the handheld computer 1 so that users can type in completely correspondingly. In step S3, a user inputs text and/or symbols 212 by using an IME (Input Method Editor) of the WINDOWS operating system and the WINDOWS input mode. The IME can be typically implemented by the keyboard 22. Of course, other input methods are also available, for example, handwriting input performed by a touchpad, voice input performed by a microphone or a virtual keyboard operated by a mouse. In other words, the user can input any text and/or symbols they want by a keyboard 22 or any other input devices or methods they prefer. In step S4, the text and/or symbols which are input by a user are converted into a format acceptable by the handheld computer 1. Because the handheld computer 1 and the personal computer 2 utilize different operating systems, as abovementioned, ANDROID and WINDOWS, the text and/or symbols input by a user in the personal computer 2 must be converted to be compatible with the handheld computer 1.

Finally, in step S5, the converted text and/or symbols are converted to the handheld computer 1. Thus, the converted text and/or symbols 212 which have been converted in step S4 are shown on the first display 11 of the handheld computer 1, i.e., text and/or symbols 112 which are identical to the inputted text and/or symbols 212 shown on the second display 21 of the personal computer 2 are correspondingly shown on the first display 11 of the handheld computer 1.

In sum, a user can use a keyboard 22 of a personal computer 2 to input text and/or symbols to a handheld computer 1 which has been connected to the personal computer 2. This will be very helpful and convenient for users who need to input a large amount of text and/or symbols.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for inputting text to a handheld computer by using a personal computer with a WINDOWS operating system, comprising the steps of:
a) establishing an ADK connection between a handheld computer and a personal computer;
b) opening a WINDOWS input mode under an editing mode in the personal computer;
c) inputting text and/or symbols by using the an IME (input method editor) of the WINDOWS operating system and the WINDOWS input mode;
d) converting the text and/or symbols into a format acceptable by the handheld computer;
e) transferring the converted text and/or symbols in the step d) to the handheld computer.

2. The method of claim 1, wherein the handheld computer is a smartphone or a tablet computer.

3. The method of claim 1, wherein a connection between the handheld computer and the personal computer is a wired link.

4. The method of claim 3, wherein the wired link is a USB (universal serial bus) cable.

5. The method of claim 1, wherein the personal computer is a desktop or laptop computer.

6. The method of claim 1, wherein an input subwindow for inputting text and/or symbols is shown on the personal computer in the step b).

7. The method of claim 1, wherein text and/or symbols which are identical to the inputted text and/or symbols in the step c) are correspondingly shown on the handheld computer in the step e).

8. The method of claim 1, wherein the IME is implemented by a keyboard.
